(19) United States
(12) Patent Application Publication
(10) Pub. No.: US 2019/0157995 A1
(43) Pub. Date: May 23, 2019

(54) MAGNETIC POLE DIRECTION DETECTION DEVICE

(71) Applicant: Yoji Mori, Aichi (JP)

(72) Inventor: Yoji Mori, Aichi (JP)

(73) Assignee: OMRON AUTOMOTIVE ELECTRONICS CO., LTD., Aichi (JP)

(21) Appl. No.: 16/193,730

(22) Filed: Nov. 16, 2018

(30) Foreign Application Priority Data
Nov. 17, 2017 (JP) 2017-221836

(51) Int. Cl. H02P 6/16; H02K 29/08; G01D 5/14; G01D 5/244

(52) U.S. Cl. CPC H02P 6/16; H02K 29/08; B62D 15/0235; G01D 5/2448; G01D 5/145

(57) ABSTRACT

In a magnetic pole direction detection device, a magnetic pole direction calculation unit calculates a magnetic pole direction of a detecting target magnet based on detection signals output from a magnetic detection unit that detects a change in a magnetic field generated by rotation of the detecting target magnet by a magneto-resistive element including a magnetization fixed layer and a free layer and outputs detection signals having different phases. A direction correction amount calculation unit calculates a direction correction amount for correcting an error, which is caused by a magnetization direction deviation of the magnetization fixed layer generated by action of the magnetic field of the detecting target magnet and is included in the calculated magnetic pole direction. A magnetic pole direction correction unit that corrects the calculated magnetic pole direction by using the calculated direction correction amount.

### CROSS-REFERENCES TO RELATED APPLICATIONS

This application is based upon and claims the benefit of priority from Japanese Patent Application No. 2017-221836, filed on Nov. 17, 2017; the entire contents of which are incorporated herein by reference.

### FIELD

One or more embodiments of the present invention relate to a magnetic pole direction detection device, and more particularly to a magnetic pole direction detection device for detecting a magnetic pole direction of a rotor of a multiphase electric motor.

### BACKGROUND

In the related art, a technology for detecting a rotation angle of a rotating shaft of a rotor in a multiphase electric motor used for assisting steering of a steering wheel of a vehicle is known. For example, in JP-A-2004-150931, a rotation angle detection device of a motor of which a structure can be simplified without lowering detection accuracy is disclosed. The rotation angle detection device includes a magnet provided at an end portion of the rotating shaft of the motor, a magneto-resistive sensor, and a rotation angle calculation unit, and detects the rotation angle. The rotation angle detection device calculates a rotation speed and rotation acceleration based on the rotation angle, and calculates a speed correction value and an acceleration correction value according to the rotation speed and the rotation acceleration. The detected rotation angle is corrected by the speed correction value and the acceleration correction value, and a corrected rotation angle is calculated.

In JP-A-2016-050841, a magnetic detection device that suppresses manufacturing cost is disclosed. The magnetic detection device is configured to include a magnetic detection unit that detects a change in a magnetic field according to displacement of a detection target and outputs a detection signal having a different phase, a switching unit which is electrically connected to a plurality of magnetic detection units and periodically switches connection with each of the plurality of magnetic detection units, and an operational amplifier for differentially amplifying detection signals which have different phases for each of the plurality of magnetic detection units and are input via the switching unit. In the magnetic detection unit, a permanent magnet is attached to a rotating member such as a steering wheel of a vehicle, and an angle is detected using two sets of magneto-resistive sensors in which four magneto-resistive elements are disposed at 90 degrees.

### SUMMARY

However, the inventors have found that there is a limit even if it is attempted to increase the detection accuracy in the multiphase electric motor in a case where the rotation angle of the rotating shaft is detected by utilizing the change in the magnetic field of the permanent magnet provided at the tip of the rotating shaft of the multiphase electric motor by using a magnetic sensor having a tunneling magneto-resistive element as in the related art. As a result of intensive studies for the purpose of improving the detection accuracy, the inventors found that a magnetization direction of a magnetization fixed layer of the tunneling magneto-resistive element is slightly inclined in a case where a magnetic field intensity is strong, which leads to occurrence of advance and delay of a phase.

Accordingly, one or more embodiments of the present invention are intended to provide a magnetic pole direction detection device which includes a tunneling magneto-resistive element and improves detection accuracy in a magnetic pole direction of a rotating shaft by correcting an error caused by a magnetization direction deviation of a magnetization fixed layer in the magnetic pole direction detection device.

In order to solve the problems described above, there is provided a magnetic pole direction detection device for detecting a magnetic pole direction of a detecting target magnet attached to a tip of a rotating shaft. The magnetic pole direction detection device includes a magneto-resistive element that includes a magnetization fixed layer and a free layer, a magnetic detection unit that detects a change in a magnetic field generated by rotation of the detecting target magnet by the magneto-resistive element and outputs detection signals having different phases, a magnetic pole direction calculation unit that calculates a magnetic pole direction of the detecting target magnet based on the detection signals output from the magnetic detection unit, a direction correction amount calculation unit that calculates a direction correction amount for correcting an error, which is caused by the magnetization direction deviation of the magnetization fixed layer of the magneto-resistive element generated by action of the magnetic field of the detecting target magnet and is included in the magnetic pole direction calculated by the magnetic pole direction calculation unit, and a magnetic pole direction correction unit that corrects the magnetic pole direction calculated by the magnetic pole direction calculation unit by using the direction correction amount calculated by the direction correction amount calculation unit.

According to this configuration, it is possible to provide the magnetic pole direction detection device in which detection accuracy in the magnetic pole direction of the rotating shaft is improved by correcting the error caused by the magnetization direction deviation of the magnetization fixed layer.

According to one or more embodiments of the present invention, it is possible to provide a magnetic pole direction detection device which includes a tunneling magneto-resistive element and improves detection accuracy in the magnetic pole direction of the rotating shaft by correcting the error caused by the magnetization direction deviation of the magnetization fixed layer in the magnetic pole direction detection device.

### BRIEF DESCRIPTION OF DRAWINGS

FIG. 1 is a block diagram of a multiphase electric motor control device to which a magnetic pole direction detection device according to a first embodiment of the present invention is applied;

FIG. 2 is a schematic cross-sectional view of a three-phase electric motor to which the magnetic pole direction detection device according to the first embodiment of the present invention is applied, in a cross-section in the rotating shaft direction;

FIG. 3 is a schematic cross-sectional view of the three-phase electric motor to which the magnetic pole direction detection device according to the first embodiment of the present invention is applied, in a cross-section perpendicular to the rotating shaft;

FIG. 4 is an explanatory view for explaining a magnetic detection unit in the magnetic pole direction detection device according to the first embodiment of the present invention;

FIG. 5 is an explanatory view for explaining a change in a relationship between a magnetic field generated from a detecting target magnet and the magnetic detection unit in the cross-section perpendicular to the rotating shaft of the three-phase electric motor to which the magnetic pole direction detection device according to the first embodiment of the present invention is applied;

FIG. 6 is a block diagram illustrating the magnetic detection unit and the like in the magnetic pole direction detection device according to the first embodiment of the present invention;

FIG. 7 is an explanatory view illustrating an output voltage waveform of the magnetic detection unit in the magnetic pole direction detection device according to the first embodiment of the present invention;

FIGS. 8A to 8C are schematic diagrams illustrating a tunneling magneto-resistive element, in which FIG. 8A is a schematic diagram in the case where the magnetization directions of a free layer and a magnetization fixed layer are parallel, FIG. 8B is a schematic diagram in the case where the magnetization directions of the free layer and the magnetization fixed layer are antiparallel, and FIG. 8C is a schematic diagram illustrating how the direction of the magnetic pole of the free layer changes by the magnetic field of the detecting target magnet;

FIGS. 9A to 9E are explanatory diagrams for explaining that a deviation in a magnetic pole direction occurs in a tunneling magneto-resistive element;

FIG. 10 is a graph illustrating a change in a resistance value of one tunneling magneto-resistive element within a second bridge circuit (Cos waveform) in a case where the deviation in the magnetic pole direction occurs in the tunneling magneto-resistive element;

FIG. 11A is a graph illustrating an output voltage of the second bridge circuit (Cos waveform), FIG. 11B is a graph illustrating an output voltage of a first bridge circuit (Sin waveform), and FIG. 11C is a graph illustrating an angle error, in a case where the deviation in the magnetic pole occurs in the tunneling magneto-resistive element;

FIG. 12A is a schematic view of the magnetic detection unit, FIG. 12B is a schematic view of the first bridge circuit within the magnetic detection unit, and FIG. 12C is a schematic view of the second bridge circuit within the magnetic detection unit, in the magnetic pole direction detection device according to the first embodiment of the present invention;

FIG. 13A is a schematic view illustrating a magnetic pole direction in a case where the deviation in the magnetization direction is not considered in the magnetization fixed layer of the tunneling magneto-resistive element, FIG. 13B is a schematic view illustrating the magnetic pole direction of R1 in a case where the deviation in the magnetization direction is considered in the magnetization fixed layer of the tunneling magneto-resistive element in the magnetic pole direction detection device of the first embodiment according to the present invention, and FIG. 13C is a schematic view illustrating the magnetic pole direction of R2 in a case where the deviation in the magnetization direction is considered in the magnetization fixed layer of the tunneling magneto-resistive element in the magnetic pole direction detection device of the first embodiment according to the present invention;

FIG. 14 is a control block diagram of the magnetic pole direction detection device according to the first embodiment of the present invention; and

FIG. 15 is an explanatory view illustrating a measurement system of a magnetic pole direction detection device of a modification example of the first embodiment according to the present invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

### First Embodiment

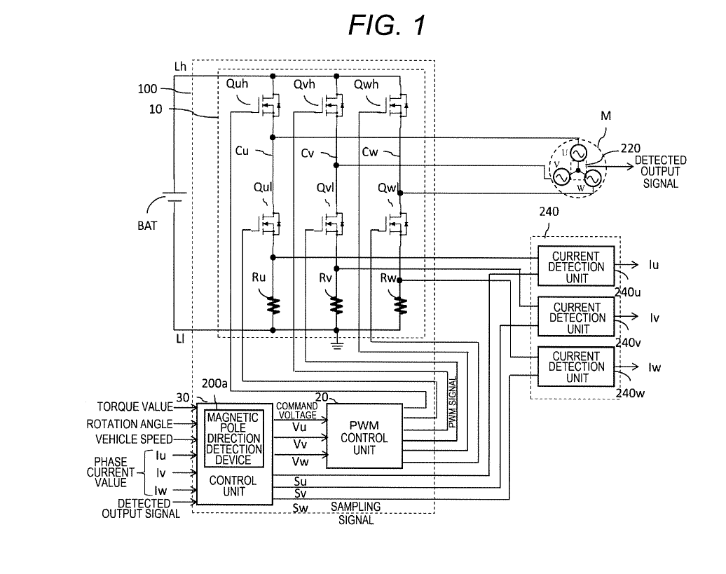

With reference to FIG. 1, a three-phase electric motor M and a multiphase electric motor control device 100 to which a magnetic pole direction detection device 200 according to this embodiment is applied will be described. The multiphase electric motor control device 100 is a three-phase brushless motor used for an electric power steering device (not illustrated) of a vehicle and the like, and drives and controls the three-phase electric motor M that gives an assisting force to a steering operation. The multiphase electric motor control device 100 includes a bridge circuit 10 configured by connecting phase circuits Cu, Cv, and Cw corresponding to phases U, V, and W of the three-phase electric motor M in parallel, a PWM control unit 20 that outputs a pulse width modulation (PWM) signal to each phase of the bridge circuit 10, and a control unit 30 that controls the entire device. The three-phase electric motor M includes a magnetic detection unit 220 and the like and outputs a signal relating to a detected magnetic pole direction. The magnetic detection unit 220 and the like will be described later.

The bridge circuit 10 is connected to a positive electrode side of a battery BAT via a power supply line Lh and is connected (grounded) to a negative electrode side of the battery BAT via a ground line Ll. The phase circuits Cu, Cv, and Cw of the bridge circuit 10 have high potential side switching elements Quh, Qvh, and Qwh provided on the power line Lh side, low potential side switching elements Qul, Qvl, and Qwl provided on the ground line Ll side, and current detectors Ru, Rv, and Rw provided closest to the ground line Ll side in series which are connected in series. In this embodiment, as the high-potential side switching element Quh, Qvh, and Qwh and the low-potential side switching element Qul, Qvl, and Qwl, MOSFETs, that is, metal oxide semiconductor field effect transistors are used.

Each of drains of the high-potential side switching elements Quh, Qvh, and Qwh is connected to the power supply line Lh. Each of sources of the high-potential side switching elements Quh, Qvh, and Qwh is connected to each of drains of the low-potential side switching elements Qul, Qvl, and Qwl. Each of sources of the low-potential side switching elements Qul, Qvl, and Qwl is connected to the ground line Ll via current detectors Ru, Rv, and Rw. Each of the high-potential side switching elements Quh, Qvh, and Qwh and each of the low-potential side switching elements Qul, Qvl, and Qwl receive the PWM signal generated by the PWM control unit 20 at its gate, and a source-drain path is turned on or off.

Each of the current detectors Ru, Rv, and Rw is a resistor (shunt resistor) for current detection and is provided on the lower potential side (ground side) than the low potential side switching elements Qul, Qvl, and Qwl, and detects the current supplied from the bridge circuit 10 to each of the phases U, V, and W of the three-phase electric motor M by a method described later. Normally, the three-phase electric motor M of the electric power steering apparatus is supplied with driving power by energizing a sinusoidal wave. At that time, since feedback of the current value of each of the phases U, V, and W is required, the current detectors Ru, Rv, and Rw are provided for detecting the current of each phase in each of the phase circuits Cu, Cv, and Cw. The sine wave to be energized is a pseudo sinusoidal wave generated by PWM control using an inverter.

Each of connection points of the high-potential side switching elements Quh, Qvh, and Qwh and the low-potential side switching elements Qul, Qvl, and Qwl is connected to each of coils of the phases U, V, and W of the three-phase electric motor M. Each of connection points of the low-potential side switching elements Qul, Qvl, and Qwl and the current detectors Ru, Rv, and Rw is connected to each of current detection units 240u, 240v, and 240w that respectively output phase current values Iu, Iv, and Iw obtained by converting a phase current value of an analog value of each of the phase circuits Cu, Cv, and Cw into a digital value. Each of connection points of the low potential side switching elements Qul, Qvl, and Qwl and the current detectors Ru, Rv, and Rw is connected to each of the current detection units 240u, 240v, and 240w that outputs the phase current values Iu, Iv, and Iw. A voltage drop proportional to the current value occurs in the current detectors Ru, Rv, and Rw due to the phase current flowing in the phase circuits Cu, Cv, and Cw. Although the voltage drop value is an analog value, the voltage drop value is converted into the phase current value Iu, Iv, and Iw and output as a digital value.

The control unit 30 receives a voltage value corresponding to each of the phase current values Iu, Iv, and Iw output from each of the current detection units 240u, 240v, and 240w, a steering torque value of a steering wheel obtained from another sensor or electric control unit (ECU) (not illustrated), a rotation angle (electrical angle) of the three-phase electric motor M, and a vehicle speed as inputs. The control unit 30 further receives a signal concerning the magnetic pole direction detected by the magnetic detection unit 220 of the three-phase electric motor M as an input. Based on the steering torque value given to the steering wheel by the driver at the time of the vehicle speed, the rotational angle of the three-phase electric motor M corrected by the magnetic pole direction detection device 200 to be described later, and each of the phase current values Iu, Iv, and Iw detected by each of the current detection units 240u, 240v, and 240w, the control unit 30 calculates each of command voltages Vu, Vv, and Vw for each phase corresponding to the assisting force as the target value to be given to the steering wheel by the three-phase electric motor M, and outputs the command voltages to the PWM control unit 20. The control unit 30 is constituted with a microcomputer including a CPU and a memory.

The PWM control unit 20 generates each of duty instruction values Du, Dv, and Dw based on each of the command voltages Vu, Vv, and Vw of each of the phases output from the control unit 30. The PWM control unit 20 generates PWM signals for rotationally driving the three-phase electric motor M based on the duty instruction values Du, Dv, and Dw, and outputs the PWM signals to the high potential side switching elements Quh, Qvh, and Qwh and the low potential side switching elements Qul, Qvl, and Qwl. The PWM signals are input to gates of the high-potential side switching elements Quh, Qvh, and Qwh and gates of the low-potential side switching elements Qul, Qvl, and Qwl, respectively, and the bridge circuit 10 converts electric power of the battery BAT as a DC power supply by PWM control and supplies the converted electric power to the three-phase electric motor M.

The control unit 30 outputs each of sampling signals Su, Sv, and Sw for instructing the timing at which each of the current detection units 240u, 240v, and 240w measures the current to each of the current detection units 240u, 240v, and 240w. How the current is measured at what timing will be described later. The current detection units 240u, 240v, and 240w measure the currents of respective phases based on the sampling signals Su, Sv, and Sw and feed the phase current values Iu, Iv, and Iw back to the control unit 30.

The control unit 30 includes a part 200a of the magnetic pole direction detection device 200 described later. The part 200a of the magnetic pole direction detection device 200 is a magnetic pole direction calculation unit 230, a direction correction amount calculation unit 260, and a magnetic pole direction correction unit 270 which will be described later. The control unit 30 receives a signal concerning the magnetic pole direction detected by the magnetic detection unit 220 of the three-phase electric motor M as an input and delivers the signal to the part 200a of the magnetic pole direction detection device 200. In this embodiment, the magnetic pole direction detection device 200 is illustrated as a part of the control unit 30 of the microcomputer, but is not limited thereto. The magnetic pole direction detection device 200 may be provided in a different microcomputer.

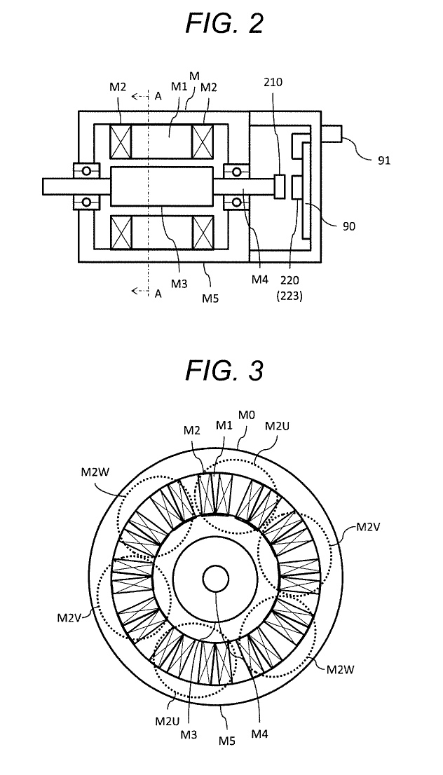

With reference to FIGS. 2 and 3, the three-phase electric motor M will be described. The three-phase electric motor M includes a rotating shaft M4, a magnetized rotor M3 fixed to the rotating shaft M4, a multiphase coil M2 wound around a stator M1 provided at a position facing the rotor M3, a case M5 including the multiphase coil M2 on its inner wall, a detecting target magnet 210 including a pair of magnetic poles attached to the tip of the rotating shaft M4, a magnetic detection unit 220 including a tunneling magneto-resistive element 223, a substrate 90 including various circuits, and a connector 91 for connecting a power supply and a torque signal and the like. The multiphase coil M2 includes a U-phase coil M2U corresponding to the U phase, a V-phase coil M2V corresponding to the V phase, and a W-phase coil M2W corresponding to the W phase, and has three phases. These constitutional elements may be known as elements. The magnetic detection unit 220 is provided on the substrate 90 at a position corresponding to the detecting target magnet 210 with an appropriate distance therebetween. The substrate 90 includes circuits such as the control unit 30 for controlling the motor M, the current detection unit 240, the PWM control unit 20, and the bridge circuit 10.

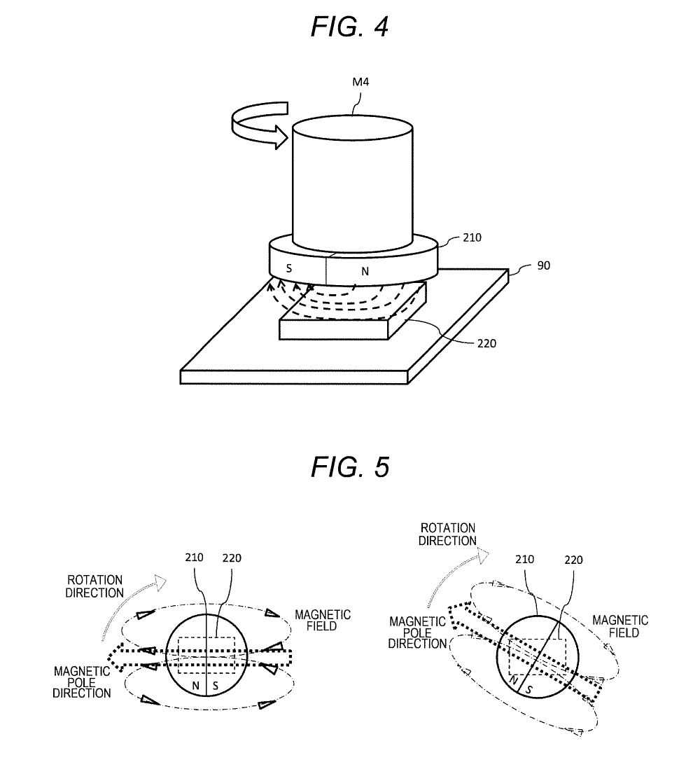

With reference to FIGS. 4 and 5, the magnetic detection unit 220 and the detecting target magnet 210 will be described. The detecting target magnet 210 has a columnar shape and is magnetized such that one of the semicircular columns is N pole and the other is S pole. Accordingly, the detecting target magnet 210 forms a magnetic field (one-dot chain line) in which magnetic field lines emerges from the N pole and enters the S pole, and the magnetic pole direction is the direction from the S pole to the N pole inside the magnet as indicated by the dotted arrow. The magnetic detection unit 220 is provided at a position included in the magnetic field formed by the detection magnet 210 with an appropriate strength.

Since the magnetic detection unit 220 is fixed to the substrate 90 and the detecting target magnet 210 is fixed to the tip of the rotating shaft M4, when the 3-phase electric motor M is operated and the rotating shaft M4 rotates, the magnetic field (dotted line) of the detecting target magnet 210 rotates with respect to the magnetic detection unit 220, which causes a change in the density and direction of the magnetic flux. That is, the magnetic field by the detecting target magnet 210, which is a permanent magnet, rotates as the rotating shaft M4 rotates. Then, the tunneling magneto-resistive element 223 of the magnetic detection unit 220 detects the change in the magnetic field as the magnetic flux crosses. The magnetic field illustrated in the figure is a schematic representation of a part thereof.

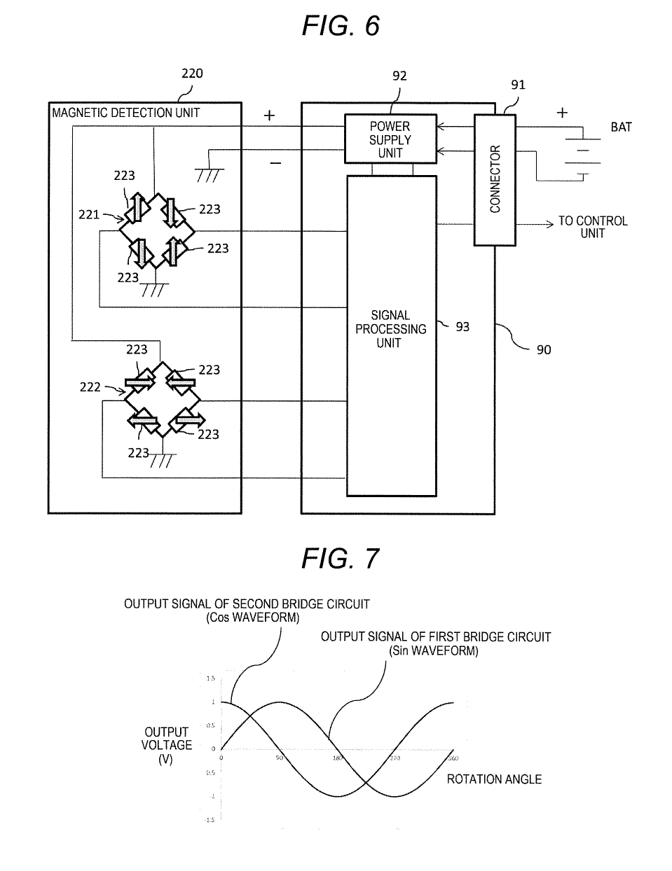

As illustrated in FIG. 6, the magnetic detection unit 220 includes two magnetic detection units, that is, a first bridge circuit 221 and a second bridge circuit 222 each of which includes four tunneling magneto-resistive elements 223. Each of the four magneto-resistive elements 223 is connected so as to form a Wheatstone bridge. The tunneling magneto-resistive element 223 exhibits the same resistance value in a case where a magnetic field is not acting. Since an electric resistance of the tunneling magneto-resistive element 223 changes according to a change in the magnetic field, the tunneling magneto-resistive element 223 is supplied with electric power from the direct current power supply BAT via the connector 91 and a power supply unit 92. When there is a change in the magnetic field, the tunneling magneto-resistive element 223 changes the voltage accordingly and outputs the voltage. In a case where the magneto-resistive element 223 is, for example, a tunneling magneto-resistive sensor (TMR), the first bridge circuit 221 and the second bridge circuit 222 are configured in such a way that the magnetization direction of the magnetization fixed layer is opposite to the direction of the magneto-resistive element 223 on the high potential side and the magneto-resistive element 223 on the low potential side and corresponding magneto-resistive elements in the right bridge and the left bridge are in opposite directions. The direction of the arrow in the figure indicates the magnetization direction of the magneto-resistive element 223.

The magnetization directions of the TMR sensors of the first bridge circuit 221 and the second bridge circuit 222 are arranged so as to be deviated by 90 degrees as a whole. That is, detection directions of magnetism of the first bridge circuit 221 and the second bridge circuit 222 are different by 90 degrees. In other words, the magnetization direction of the tunneling magneto-resistive element 223 of the first bridge circuit 221 and the magnetization direction of the tunneling magneto-resistive element 223 of the second bridge circuit 222 are orthogonal to each other. Since the electric resistance of the tunneling magneto-resistive element 223 changes according to the magnetic field intensity by rotation of the detecting target magnet 210, a waveform of the voltage output from the first bridge circuit 221 and a waveform of the voltage output from the second bridge circuit 222 are a Sin waveform and a Cos waveform that are 90 degrees out of phase with each other, respectively, as illustrated in FIG. 7. Accordingly, the magnetic detection unit 220 outputs a Sin signal of the Sin waveform output from the first bridge circuit 221 and a Cos signal of the Cos waveform output from the second bridge circuit 222. The waveform of the voltage output from the first bridge circuit 221 and the voltage output from the second bridge circuit 222 are voltages at the midpoint potentials of two tunneling magneto-resistive elements 223 in each of the first bridge circuit 221 and second bridge circuit 222. The signal processing unit 93 receives the electric signal relating to the output voltage, processes the electric signal, and outputs a signal detected with respect to the magnetic pole direction to the control unit 30.

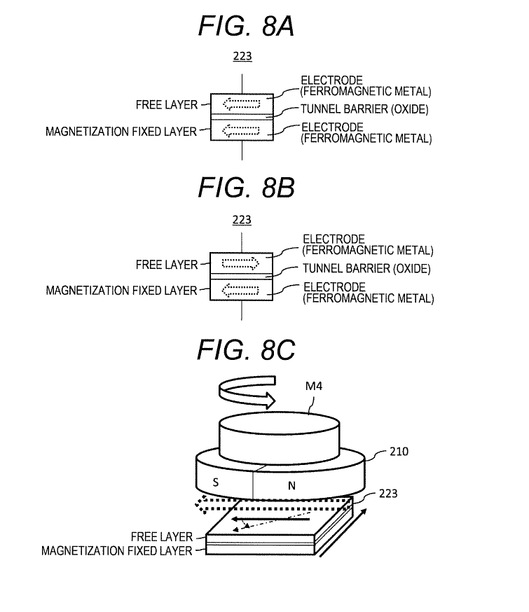

The tunneling magneto-resistive element 223 is an element that has a structure in which a tunnel barrier formed of a thin oxide film is sandwiched between electrodes of ferromagnetic metal from both sides, and detects a change in a magnetic field by utilizing a phenomenon that a tunnel current flows due to application of a magnetic field from the outside and the electric resistance changes. The electrode is constituted with a free layer of which the magnetic pole direction is changed by an external magnetic field and an invariant magnetization fixed layer of which the magnetic pole direction is fixed. As illustrated in FIG. 8A, in a case where a magnetic field acts so that the magnetic pole direction of the free layer becomes the same direction (parallel) as the magnetization direction of the magnetization fixed layer, the electric resistance of the tunneling magneto-resistive element 223 becomes small. As illustrated in FIG. 8B, in a case where the magnetic field acts so that the magnetic pole direction of the free layer becomes a direction opposite (antiparallel) to the magnetization direction of the magnetization fixed layer, the electric resistance of the tunneling magneto-resistive element 223 becomes large.

FIG. 8C illustrates how the direction of the magnetic pole of the free layer changes as the magnetic field (dotted arrow) of the detecting target magnet 210 fixed to the tip of the rotating shaft M4 changes due to rotation. The magnetization direction of the magnetization fixed layer does not change even when the magnetic field of the detecting target magnet 210 changes and faces a constant direction, but the magnetic pole direction of the free layer rotates and changes as the magnetic field of the detection magnet 210 changes. In FIG. 8C, the magnetic pole direction of the free layer changes from a solid arrow to a one-dot chain arrow as the magnetic field of the detecting target magnet 210 rotates.

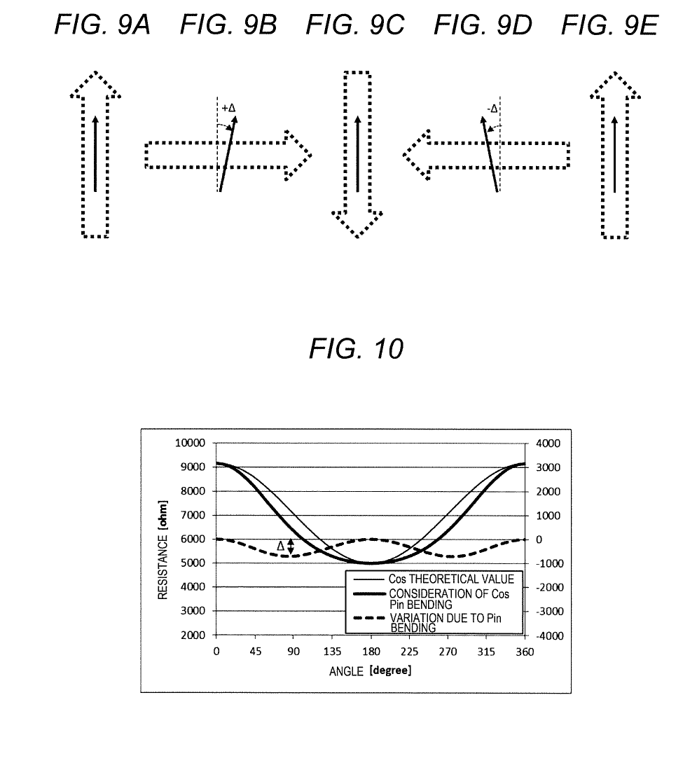

Normally, as described above, since the magnetization direction of the magnetization fixed layer is fixed, the magnetization direction does not change. However, the inventors have found that in an environment where the magnetic field intensity is high, such as bringing the detecting target magnet 210 close to the magnetic detection unit 220, the magnetization direction of the magnetization fixed layer is also slightly changed by being dragged by the change in the magnetic field of the detecting target magnet 210. The change in the magnetization direction of the magnetization fixed layer will be described with reference to FIGS. 9A to 9E.

FIG. 9A illustrates a case where the magnetization direction (solid arrow) of the magnetization fixed layer and the magnetic pole direction (dotted arrow) of the detecting target magnet 210 coincide with each other. FIG. 9B illustrates a case where the direction of the magnetic pole of the detecting target magnet 210 rotates clockwise by 90 degrees from the state where the magnetization direction of the magnetization fixed layer and the magnetic pole direction of the detecting target magnet 210 illustrated in FIG. 9A coincide with each other. In this case, the magnetization direction of the magnetization fixed layer changes in the clockwise direction (+ direction) by a minute angle Δ by being dragged by the change in the magnetic pole direction of the detecting target magnet 210.

FIG. 9C illustrates a case where the magnetic pole direction of the detecting target magnet 210 is further rotated clockwise by 90 degrees from the state where the magnetization direction of the magnetization fixed layer and the magnetic pole direction of the detection magnet 210 illustrated in FIG. 9B form 90 degrees, and illustrates a state in which the angle formed between the magnetization direction of the magnetization fixed layer and the magnetic pole direction of the detecting target magnet 210 is 180 degrees. That is, the magnetization direction of the magnetization fixed layer and the magnetic pole direction of the detecting target magnet 210 are in opposite directions. In this case, since the magnetization direction of the magnetization fixed layer does not rotate by being dragged by the change in the magnetic pole direction of the detecting target magnet 210 like the magnetic pole direction of the free layer, the magnetization direction of the magnetization fixed layer returns to the original magnetization direction of the magnetization fixed layer.

FIG. 9D illustrates a case where the magnetic pole direction of the detecting target magnet 210 is further rotated clockwise by 90 degrees from the state where the magnetization direction of the magnetization fixed layer illustrated in FIG. 9C and the magnetic pole direction of the detecting target magnet 210 are in the opposite directions, and the magnetization direction of the magnetization fixed layer and the magnetic pole direction of the detecting target magnet 210 form 270 degrees (−90 degrees). In this case, the magnetization direction of the magnetization fixed layer is pulled in the magnetic pole direction of the detecting target magnet 210 and changes in the counterclockwise direction (− direction) by the minute angle Δ.

FIG. 9E illustrates a case where the magnetic pole direction of the detecting target magnet 210 is further rotated clockwise by 90 degrees from the state where the magnetization direction of the magnetization fixed layer and the magnetic pole direction of the detecting target magnet 210 illustrated in FIG. 9D form −90 degrees, and illustrates a case where the magnetization direction of the magnetization fixed layer and the magnetic pole direction of the detecting target magnet 210 coincide with each other, similarly to FIG. 9A. As such, while the detecting target magnet 210 makes one revolution (360 degrees), the magnetization direction of the magnetization fixed layer causes a deviation from the original magnetization direction of the magnetization fixed layer to the minute angle Δ twice.

FIG. 10 illustrates a change in the resistance value of one tunneling magneto-resistive element 223 within the second bridge circuit 222 (Cos waveform). In the graph, the vertical axis on the left side represents the resistance value of one tunneling magneto-resistive element and the vertical axis on the right side represents the resistance value on the error Δ. The thin solid line illustrates a theoretical resistance value not considering the deviation in the magnetization direction of the magnetization fixed layer described above, and the thick solid line illustrates an actually measured resistance value in the case where the deviation (denoted as “Pin bending” in the figure) of the magnetization direction of the magnetization fixed layer is considered to occur. When the angle is 0 to 180 degrees, the phase of the resistance value slightly advances, and when the angle is 180 to 360 degrees, the phase of the resistance value is slightly delayed in phase. Accordingly, the error from the theoretical value of the resistance value accompanying the deviation in the magnetization direction of the magnetization fixed layer illustrates a fluctuation in amplitude of a minute value Δ over a half cycle as illustrated by a dotted line.

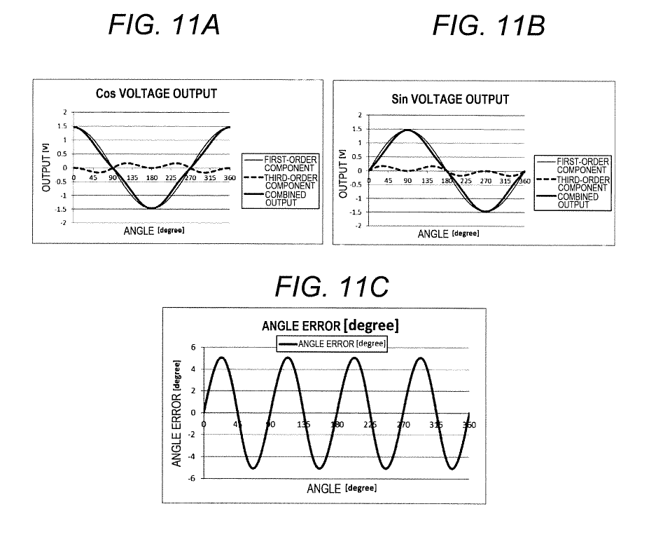

Variation in the resistance value of one tunneling magneto-resistive element 223 in the second bridge circuit 222 (Cos waveform) also affects the voltage output of the entire second bridge circuit 222. The thick solid line (combined output) in FIG. 11A illustrates the voltage output from the second bridge circuit 222, and this voltage is obtained by combining errors of the resistance values in the four tunneling magneto-resistive elements 223 and exhibits complex phase advance or delay. Similarly, the thick solid line in FIG. 11B illustrates the voltage output from the first bridge circuit 221.

When an arctangent is calculated based on the Cos waveform from the second bridge circuit 222 and the Sin waveform of the first bridge circuit 221, an angle including an error is obtained. Separately, if the difference between the true value of the measured angle and the angle including the error is obtained, the angle of the error can be obtained, but the angle of the error is illustrated in FIG. 11C. As illustrated in FIG. 11C, an error occurs over a quarter cycle of a rotation period of the detecting target magnet 210. The embodiment of the present invention improves detection accuracy in the magnetic pole direction of the detecting target magnet 210, that is, the rotor M3, by considering this error.

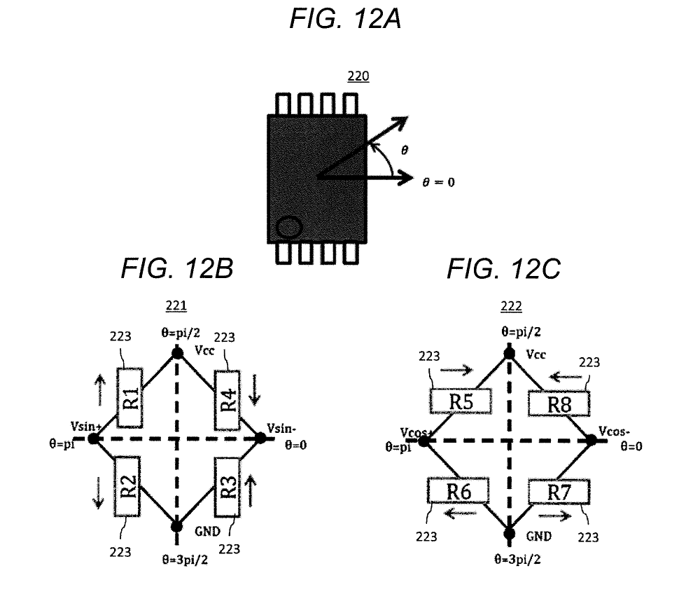

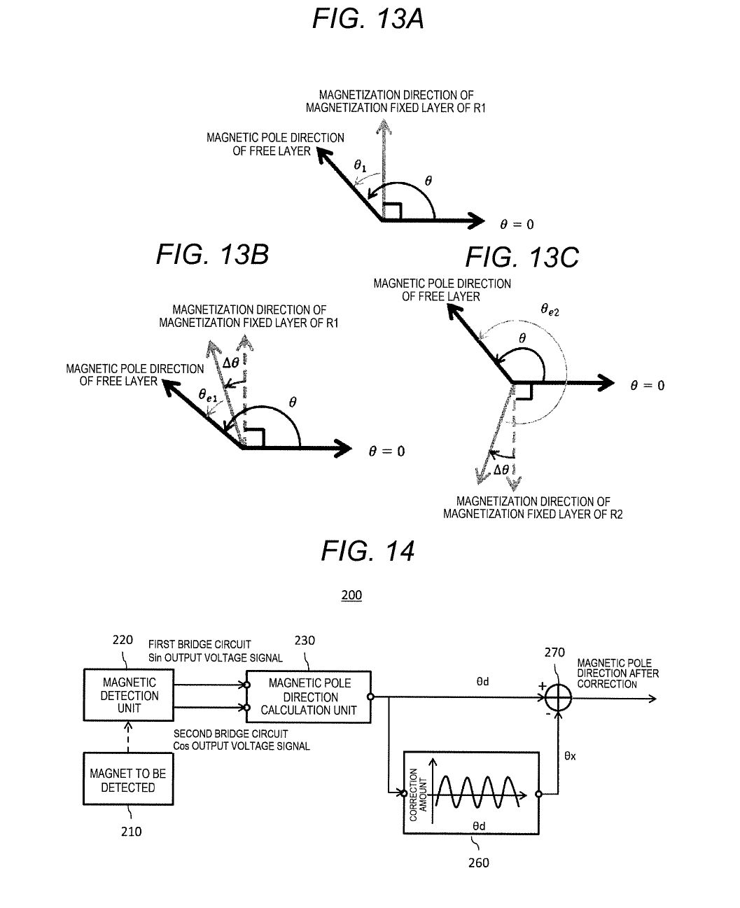

Description will be made in more detail with reference to FIGS. 12, 13 and the following mathematical expressions. FIG. 12A illustrates the magnetic detection unit 220, and the magnetic detection unit 220 internally includes a first bridge circuit 221 (Sin waveform) illustrated in FIG. 12B and a second bridge circuit 222 (Cos waveform) illustrated in FIG. 12C. The magnetic detection unit 220 detects an angle θ of how much the magnetic pole direction of the detecting target magnet 210 has changed from θ=0 in the figure, by the output voltage.

The magnetization direction of the magnetization fixed layer of the first bridge circuit 221 is disposed so as to form a direction perpendicular to the direction of θ=0 as illustrated in FIG. 12B, and among the tunneling magneto-resistance elements 223, R1 and R3 are oriented in the direction of +90 degrees and R2 and R4 are oriented in the direction of −90 degrees (+270 degrees). The magnetization direction of the magnetization fixed layer of the second bridge circuit 222 is disposed so as to form a direction parallel to the direction of θ=0 as illustrated in FIG. 12C, and among the tunneling magneto-resistance elements 223, R5 and R7 are oriented in the direction of 0 degree and R6 and R8 are oriented in the direction of +180 degrees.

In the first bridge circuit 221, the connection point between R2 and R3 is connected to the ground, a voltage Vcc of the power supply unit 92 is applied to the connection point between R1 and R4, and an output voltage (Vₛᵢₙ₊) is obtained from the connection point between R1 and R2 and an output voltage (V sin−) is obtained from the connection point between R3 and R4. In the second bridge circuit 222, a connection point between R6 and R7 is connected to the ground, the voltage Vcc of the power supply unit 92 is applied to a connection point between R5 and R8, and an output voltage (V cos+) is obtained from the connection point between R5 and R6 and an output voltage (V cos−) is obtained from the connection point between R7 and R8.

First, a case where the deviation in the magnetization direction of the magnetization fixed layer of the tunneling magneto-resistive element 223 is not considered will be described. As illustrated in FIG. 13A, in a case where the direction of the magnetic pole of the detecting target magnet 210 is θ, the magnetic pole direction of the free layer also is directed toward the direction of θ. At this time, for example, since the magnetization direction of the magnetization fixed layer of R1 does not change, the magnetization direction of the magnetization fixed layer of R1 keeps directing towards +90 degrees. Then, the angle formed by the magnetic pole direction of the free layer and the magnetization direction of the magnetization fixed layer is θ₁. In the following description, the angles formed by the magnetic pole direction of the free layers and the magnetization direction of the magnetization fixed layers in R1 to R8 are defined as θ₁ to θ₈.

The angles formed by the magnetic pole directions of the free layers and the magnetization directions of the magnetization fixed layers in R1 to R4 of the first bridge circuit 221 are as follows.

θ₁=θ−Π/2

θ₂=θ−3Π/2

θ₃=θ−Π/2

θ₄=θ−3Π/2

Since a general expression for obtaining a resistance value of a bridge circuit is

Rn(θn)=R0−rR0 Cos θn(n=1 to 8),

the resistance values at R1 to R4 are as follows. R0 is a median value of the resistance values, and r is a resistance variation rate.

R1(θ₁)=R0−rR0 Cos θ₁

R2(θ₂)=R0−rR0 Cos θ₂

R3(θ₃)=R0−rR0 Cos θ₃

R4(θ₄)=R0−rR0 Cos θ₄

Similarly, R5 to R8 of the second bridge circuit 222 are as follows.

θ₅=θ

θ₆=θ−Π

θ₇=θ

θ₈=θ−Π

R5(θ₅)=R0−rR0 Cos θ₅

R6(θ₆)=R0−rR0 Cos θ₆

R7(θ₇)=R0−rR0 Cos θ₇

R8(θ₈)=R0−rR0 Cos θ₈

In the first bridge circuit 221 and the second bridge circuit 222, according to Kirchhoff's law, the following expressions are established. I_{sin±} and I_{cos±} are the current values of the first bridge circuit 221 and the second bridge circuit 222.

Vcc−R1Iₛᵢₙ₊−R2Iₛᵢₙ₊=0

Vcc−R4Iₛᵢₙ₋−R3Iₛᵢₙ₋=0

Vcc−R5I_{cos+}−R6I_{cos+}=0

Vcc−R8I_{cos-}−R7I_{cos-}=0

When these expressions are summarized according to the current value, the expressions become as follows.

Iₛᵢₙ₊=Vcc/(R1+R2)

Iₛᵢₙ₋=Vcc/(R3+R4)

I_{cos+}=Vcc/(R5+R6)

I_{cos-}=Vcc/(R7+R8)

The output voltage Vₛᵢₙ₊ at the connection point of R1 and R2 and the output voltage Vₛᵢₙ₋ at the connection point of R3 and R4 of the first bridge circuit 221, and the output voltage V_{cos+} at the connection point of R5 and R6 and the output voltage V_{cos-} at the connection point of R7 and R8 of the second bridge circuit 222 are represented by the following expressions.

Vₛᵢₙ₊=Vcc−R1Iₛᵢₙ₊

Vₛᵢₙ₋=Vcc−R4Iₛᵢₙ₋

V_{cos+}=Vcc−R5I_{cos+}

V_{cos-}=Vcc−R8I_{cos-}

When the current values are substituted into these expressions, the followings are obtained.

$$\begin{matrix}\begin{matrix}{V}_{sin +} = Vcc - R 1 Vcc \text{/} ( R 1 + R 2 ) \\ = R 2 Vcc \text{/} ( R 1 + R 2 ) \\ = ( R 0 + rR 0 Sin θ ) Vcc \text{/} 2 R 0\end{matrix} & ( 10 ) \\ {V}_{sin -} = ( R 0 - rR 0 Sin θ ) Vcc \text{/} 2 R 0 & ( 11 ) \\ {V}_{cos +} = ( R 0 + rR 0 Cos θ ) Vcc \text{/} 2 R 0 & ( 12 ) \\ {V}_{cos -} = ( R 0 - rR 0 Cos θ ) Vcc \text{/} 2 R 0 & ( 13 )\end{matrix}$$

As such, the output voltages of the respective bridge circuits can be obtained in the case where the direction of the magnetic pole of the detecting target magnet 210 is θ, by the expressions (10) to (13) described above.

A case where the deviation in the magnetization direction of the magnetization fixed layer of the tunneling magneto-resistive element 223 is considered will be described. As illustrated in FIG. 13B, in a case where the direction of the magnetic pole of the detecting target magnet 210 is θ, the magnetic pole direction of the free layer is also directed toward the direction θ. At this time, for example, the magnetization direction of the magnetization fixed layer of R1 is dragged in the magnetic pole direction of the detecting target magnet 210, and is deviated so as to approach the magnetic pole direction of the free layer by Δθ as compared with the case where there is no deviation. Here, Δθ is as follows.

In the case of first bridge circuit 221: Δθ=BC Cos θ

In the case of second bridge circuit 222: Δθ=BC Sin θ

Here, B is magnetic flux density of the detecting target magnet 210 in the tunneling magneto-resistive element 223 and C is the intrinsic coefficient of the tunneling magneto-resistive element 223.

Then, the angle formed by the magnetic pole direction of the free layer and the magnetization direction of the magnetization fixed layer in R1 is θₑ₁. Similarly, as illustrated in FIG. 13C, the magnetization direction of the magnetization fixed layer of R2 is pulled in the magnetic pole direction of the detecting target magnet 210, and is deviated so as to approach the magnetic pole direction of the free layer by Δθ as compared with the case where there is no deviation. Then, the angle formed between the magnetic pole direction of the free layer and the magnetization direction of the magnetization fixed layer in R2 is θₑ₂. Hereinafter, angles θₑ₃ to θₑ₈ formed by the magnetic pole directions of the free layers and the magnetization directions of the magnetization fixed layers in R3 to R8 are also the same.

The angles formed by the magnetic pole directions of the free layers and the magnetization directions of the magnetization fixed layers in R1 to R8 of the first bridge circuit 221 and the second bridge circuit 222 are respectively as follows.

θₑ₁=θ−Π/2+Δθ

θₑ₂=θ−3Π/2−Δθ

θₑ₃=θ−Π/2+Δθ

θₑ₄=θ−3Π/2−Δθ

θₑ₅=θ−Δθ

θₑ₆=θ−Π+Δθ

θₑ₇=θ−Δθ

θₑ₈=θ−Π+Δθ

Then, the resistance values in R1 to R8 are as follows.

R1(θₑ₁)=R0−rR0 Cos θₑ₁

R2(θₑ₂)=R0−rR0 Cos θₑ₂

R3(θₑ₃)=R0−rR0 Cos θₑ₃

R4(θₑ₄)=R0−rR0 Cos θₑ₄

R5(θₑ₅)=R0−rR0 Cos θₑ₅

R6(θₑ₆)=R0−rR0 Cos θₑ₆

R7(θₑ₇)=R0−rR0 Cos θₑ₇

R8(θₑ₈)=R0−rR0 Cos θₑ₈

When these expressions are summarized in the same manner as described above, the output voltages of the first bridge circuit 221 and the second bridge circuit 222 are represented by the following expressions.

Vₛᵢₙ₊=Vcc×(R0−rR0 Sin(Δθ−θ))/(2R0−2rR0 Sin Δθ Cos θ) (20)

Vₛᵢₙ₋=Vcc×(R0−rR0 Sin(Δθ+θ))/(2R0−2rR0 Sin Δθ Cos θ) (21)

V_{cos+}=Vcc×(R0+rR0 Cos(Δθ+θ))/(2R0−2rR0 Sin Δθ Sin θ) (22)

V_{cos-}=Vcc×(R0−rR0 Cos(Δθ−θ))/(2R0−2rR0 Sin Δθ Sin θ) (23)

V sin=(Vₛᵢₙ₊)−(Vₛᵢₙ₋)=Vcc×rR0×(Sin θ×Cos Δθ/R0−rR0 Sin Δθ Cos θ) (24)

V cos=(V_{cos+})−(V_{cos-})=Vcc×rR0×(Cos θ×Cos Δθ/R0−rR0 Sin Δθ Sin θ) (25)

As described above, the output voltages of the first bridge circuit 221 and the second bridge circuit 222 of the magnetic detection unit 220 can be modeled as illustrated in expressions (20) to (25) in consideration of the deviation in the magnetization direction of the magnetization fixed layer of the tunneling magneto-resistive element 223. If the output voltage of each bridge circuit can be modeled, it is possible to correct errors caused by the deviation in the magnetization direction of the magnetization fixed layer as described later.

With reference to FIG. 14, the magnetic pole direction detection device 200 according to the embodiment of the present invention will be described. The magnetic pole direction detection device 200 is a device for detecting the magnetic pole direction of the rotor M3 in the multiphase electric motor M including the rotor M3 rotated by the magnetic field generated by the current flowing through the multiphase coil M2 wound around the stator M1. In this embodiment, the magnetic pole direction of the detecting target magnet 210 is the magnetic pole direction of the rotor M3. The magnetic pole direction detection device 200 includes the detecting target magnet 210 attached to the tip of the rotating shaft M4 of the rotor M3, the magnetic detection unit 220 that detects a change in magnetic pole direction (magnetic field) due to rotation of the detecting target magnet 210 as a voltage change of the tunneling magneto-resistive element 223, the magnetic pole direction calculation unit 230 that calculates the magnetic pole direction of the detecting target magnet 210 by calculating the arctangent based on the voltage signal of the Sin waveform and the detection signal relating to the voltage of the Cos waveform which are different in phase and are output from the magnetic detection unit 220, the direction correction amount calculation unit 260 for calculating a direction correction amount for correcting the error amount which is caused by the magnetization direction deviation of the fixed magnetization layer of the tunneling magneto-resistive element 223 generated by the action of the magnetic field of the detecting target magnet 210 and included in the magnetic pole direction calculated by the magnetic pole direction calculation unit 230, and the magnetic pole direction correction unit 270 that performs correction using the direction correction amount calculated by the direction correction amount calculation unit 260 with respect to the magnetic pole direction calculated by the magnetic pole direction calculation unit 230.

Since the magnetic pole direction θd calculated by the magnetic pole direction calculation unit 230 includes an error θx caused by the deviation (Δθ) of the magnetization direction of the magnetization fixed layer of the tunneling magneto-resistive element 223 of the magnetic detection unit 220, in a case where it is assumed that θ in the magnetic pole direction of the magnet 210 is a true magnetic pole direction, it can be expressed as θd=θ+θx. Accordingly, since θ in the magnetic pole direction of the detecting target magnet 210 is θ=θd−θx, the magnetic pole direction correction unit 270 can detect a true value of θ in the magnetic pole direction of the detecting target magnet 210 by subtracting the direction correction amount calculated by the direction correction amount calculation unit 260.

First, the procedure of calculating the magnetic pole direction θd by the magnetic pole direction calculation unit 230 will be described using the expressions (24) and (25), which are model expressions reflecting the magnetization direction deviation of the magnetization fixed layer. Δθ calculated using B (magnetic flux density of the detecting target magnet 210 in the tunneling magneto-resistive element 223) and C (intrinsic coefficient of the tunneling magneto-resistive element 223) as described above is calculated. By substituting the Δθ, R0 (median value of resistance value) previously obtained, and r (resistance variation rate) into the model expression, θ is changed to calculate V sin and V cos. For example, θ is varied at 0.1 intervals to calculate V sin and V cos for each θ. Here, θ is regarded as a true value of the magnetization direction of the detecting target magnet 210.

Then, by setting tan θd=(V sin/V cos), θd is obtained by calculating the arctangent from this and the error θx can be obtained by subtracting θ from θd. For example, θd and error θx are obtained for each θ changed by 0.1, and a correction table is created in which θd and θx are associated with each other. By using the correction table created in advance in this manner, the direction correction amount calculation unit 260 can detect the true value of the magnetic pole direction θ of the detecting target magnet 210 by subtracting the error θx corresponding to the value from the magnetic pole direction θd calculated by the magnetic pole direction calculation unit 230. According to this configuration, it is possible to provide the magnetic pole direction detection device 200 in which detection accuracy in the rotation angle (magnetic pole direction) of the rotating shaft is improved by correcting the error due to the magnetization direction deviation of the magnetization fixed layer.

As described above, the direction correction amount calculation unit 260 may derive the direction correction amount (Δθ) by calculating the amount of an angle error modeled on the basis of the output voltage of the magnetic detection unit 220, or may measure the angle error occurring in accordance with the magnetic pole direction θ of the detecting target magnet 210 in advance, prepare a direction correction amount correspondence table, and select the direction correction amount (Δθ) corresponding to the output voltage of the magnetic detection unit 220.

### Modification Example of First Embodiment

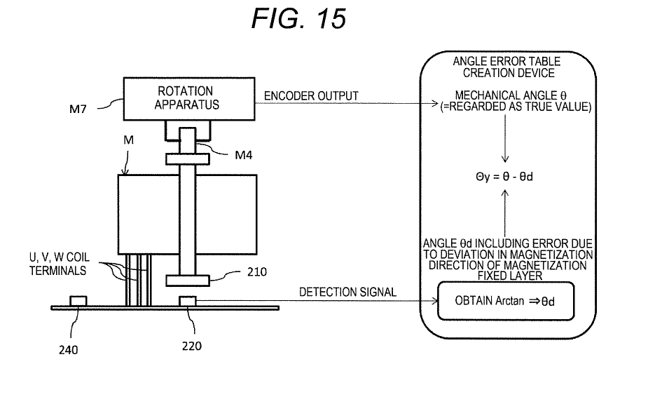

In the above description, the example in which the magnetic pole direction correction unit 270 performs correction by subtracting the direction correction amount is described, but correction may be performed by the following method. The inventors found that the magnetization direction of the magnetization fixed layer changes slightly in an environment where the magnetic field intensity is high. The inventors have made modeling as described above, have conducted a simulation for calculating the error θx for each θ on the basis of the model equation as described above, found that the error θx is pulsating at the fourth order with respect to θ. This modification example is based on such knowledge. FIG. 15 illustrates a measurement system is provided with the multiphase electric motor M including the rotating shaft M4 described above and a rotation apparatus M7 (external apparatus) for mechanically rotating the rotating shaft M4 from the outside with respect to the motor M.

Although the circuit of the multiphase electric motor control device 100 is energized, the rotation apparatus M7 rotates the rotor M4 integrated with the rotor and the detecting target magnet 210 without performing control for rotating the rotating shaft M4. The rotation apparatus M7 includes an encoder which is a sensor outputting the rotation angle of the rotating shaft M4. The rotation angle zero of the rotation axis M4 and the magnetic pole direction of the detection magnet 210 are initially set so as to coincide with each other. The encoder can accurately measure the physical rotation angle (mechanical angle) of the rotating shaft M4 (or the rotor M3). Therefore, the rotation angle θ which is the output from the encoder is regarded as the true value of the rotation angle of the rotating shaft M4, that is, the same as the magnetic pole direction of the rotating shaft M4 or the magnetic pole direction of the detecting target magnet 210.

The rotating shaft M4 is rotated at a predetermined interval (for example, 0.1 degree interval) by the rotation apparatus M7. Since the multiphase electric motor control device 100 is energized, the bridge circuit 10 of the tunneling magneto-resistive element 223 outputs the output voltages V sin and V cos at each predetermined interval. The arctangent is computed using the V sin and V cos to calculate θd, and the difference θy between the rotation angle θ (magnetic pole direction θ) of the true value obtained from the encoder output and θd is calculated. A device which calculates the values in this manner may be an angle error table creation device as illustrated in this figure. There is a possibility that the difference θy includes an error caused by a factor other than the error component caused by the deviation in the magnetization direction of the magnetization fixed layer. As described above, since it is found that the error due to the deviation in the magnetization direction of the magnetization fixed layer is the fourth order component with respect to the change of θ, the fourth order component included in variation of the measured difference θy is extracted and is obtained as the error component θx due to the deviation in the magnetization direction of the magnetization fixed layer.

The error component θx caused by the deviation in the magnetization direction of the magnetization fixed layer and an error component caused by other factors are included in θy. In order to extract only the error component θx caused by the deviation in the magnetization direction of the magnetization fixed layer, the fourth order component included in the variation of θy is obtained as follows. Consider the function f(θ) in the coordinate system having the vertical axis of θy and the horizontal axis of θ as follows.

f(θ)=A0+A1 sin(θ+B1)+A2 sin(2θ+B2)+A3 sin(3θ+B3)+A4 sin(4θ+B4)+ . . . .

A0 to An indicate amplitudes sinusoidal waves of respective orders, and B1 to Bn indicate phases of sine waves of respective orders.

For example, using a nonlinear least square method, a fitting function that fits well with θy and θ obtained by actual measurement is obtained as a function f(θ). As a result, since A4 sin(4θ+B4) which is the fourth order component is obtained, A4 sin(4θ+B4) is set as the error component θx due to the deviation in the magnetization direction of the magnetization fixed layer. Then, a correspondence table with the difference θx of θd is created, and the correspondence table is represented as a direction correction amount correspondence table. When the direction correction amount θx corresponding to θd which is the result of calculating the arctangent using V sin and V cos which are the output voltages of the magnetic detection unit 220 is selected based on the direction correction amount correspondence table created as described above, the correction amount is obtained. According to this configuration, it is possible to provide the magnetic pole direction detection device 200 in which detection accuracy in the magnetic pole direction of the rotating shaft is improved by correcting the error due to the magnetization direction deviation of the magnetization fixed layer.

The present invention is not limited to the illustrated embodiment, and can be implemented with configurations within the scope not deviating from the contents described in the respective claims. While the present invention has been particularly illustrated and described with reference to particular embodiments thereof, it will be apparent to those skilled in the art that various modifications can be made by those skilled in the art to the embodiments described above in terms of quantity and other detailed configurations.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A magnetic pole direction detection device for detecting a magnetic pole direction of a detecting target magnet attached to a tip of a rotating shaft, the magnetic pole direction detection device comprising:
a magneto-resistive element that comprises a magnetization fixed layer and a free layer;
a magnetic detection unit that detects a change in a magnetic field generated by rotation of the detecting target magnet by the magneto-resistive element and outputs detection signals having different phases;
a magnetic pole direction calculation unit that calculates a magnetic pole direction of the detecting target magnet based on the detection signals output from the magnetic detection unit;
a direction correction amount calculation unit that calculates a direction correction amount for correcting an error, which is caused by a magnetization direction deviation of the magnetization fixed layer of the magneto-resistive element generated by action of the magnetic field of the detecting target magnet and is included in the magnetic pole direction calculated by the magnetic pole direction calculation unit; and
a magnetic pole direction correction unit that corrects the magnetic pole direction calculated by the magnetic pole direction calculation unit by using the direction correction amount calculated by the direction correction amount calculation unit.

2. The magnetic pole direction detection device according to claim 1,
wherein the direction correction amount calculation unit calculates an error amount associated with each magnetic pole direction calculated by the magnetic pole direction calculation unit as the direction correction amount, and
wherein the error amount is a fourth-order component included in a difference between a magnetic pole direction measured as the magnetic pole direction of the detecting target magnet by an external apparatus and the magnetic pole direction calculated by the magnetic pole direction calculation unit.

3. The magnetic pole direction detection device according to claim 1,
wherein the direction correction amount calculation unit calculates an error amount associated with each magnetic pole direction calculated by the magnetic pole direction calculation unit as the direction correction amount, and
wherein the error amount is a difference between a magnetic pole direction calculated as the magnetic pole direction of the detecting target magnet by using a model expression reflecting the magnetization direction deviation of the magnetization fixed layer of the magneto-resistive element and a magnetic pole direction determined as a true value of the detecting target magnet which is substituted into the model expression.

4. The magnetic pole direction detection device according to claim 1,
wherein the magnetic detection unit comprises a first bridge circuit and a second bridge circuit, each of which comprises four magneto-resistive elements, and
wherein a magnetization direction of the magneto-resistive elements of the first bridge circuit and a magnetization direction of the magneto-resistive elements of the second bridge circuit are orthogonal to each other, and
wherein in each of the first bridge circuit and the second bridge circuit, the four magneto-resistive elements are connected so as to form a Wheatstone bridge.
